(19) United States
(12) Patent Application Publication
(10) Pub. No.: US 2022/0359892 A1
(43) Pub. Date: Nov. 10, 2022

(54) FUEL CELL SYSTEM AND METHOD FOR PURGING A FUEL CELL SYSTEM

(71) Applicant: AVL List GmbH, Graz (AT)

(72) Inventors: Stefan TROJER, Leisach (AT); Thomas SCHUBERT, Sankt Marein bei Graz (AT)

(73) Assignee: AVL List GmbH, Graz (AT)

(21) Appl. No.: 17/618,588

(22) PCT Filed: Jun. 10, 2020
(86) PCT No.: PCT/AT2020/060240

§ 371 Date: Dec. 13, 2021

(30) Foreign Application Priority Data
Jun. 13, 2019 (AT) A50526/2019

(51) Int. Cl. H01M 8/04223; H01M 8/04089; H01M 8/04082; H01M 8/0438

(52) U.S. Cl. CPC H01M 8/04231; H01M 8/04104; H01M 8/04201; H01M 8/04432

(57) ABSTRACT

The present invention relates to a method for adjusting an operating mode of a fuel cell system (1) comprising: at least one fuel cell stack (2) having an anode portion (3) and a cathode portion (4); an anode supply line (5) for conveying fuel from a fuel source (6) to the anode portion (3); a fuel supply device (7) for supplying the fuel in the anode supply line (5) to the anode portion (3); an anode discharge line (8) for discharging anode exhaust gas from the anode portion (3) into the environment; and a purge unit (9) for purging the anode portion (3); said method comprising the steps of: determining a purge start time and/or a purge duration in which the anode portion (3) is intended to be purged by the purge unit (9); and shifting the fuel supply device (7) from a normal operation into a fuel-supply operation specific to the purge operation on the basis of the determined purge start time and/or purge duration, wherein the shifting into the fuel-supply operation specific to the purge operation is carried out temporally before and/or during the determined purge duration. The invention also relates to a fuel cell system (1), a computer program product (16) and a memory means having a computer program product (16) stored thereon for carrying out the method according to the invention.

The present invention relates to a fuel cell system, comprising a fuel cell stack having an anode portion and a cathode portion, an anode supply line for conveying fuel from a fuel source to the anode portion, a fuel supply device for supplying the fuel in the anode supply line to the anode portion, an anode discharge line for discharging anode exhaust gas from the anode portion into the environment, and a purge unit for purging the anode portion. The invention also relates to a method for adjusting an operating mode of a fuel cell system of this kind. Moreover, the invention relates to a computer program product for carrying out a method of this kind and to a memory means for storing a computer program product.

A generic purge unit is used in a fuel cell system in an anode discharge line for purging the anode portion. The purge unit is in this case used, in particular, to convey nitrogen from inside the anode portion into the environment. The nitrogen can enter the anode portion and, from there, the anode discharge line from the cathode portion of the fuel cell stack through the membrane of the fuel cell stack. From the anode discharge line, the nitrogen can enter the anode portion again via a recirculation line and an anode supply line together with fuel, for example in the form of hydrogen. In order to intermittently discharge a mixture of this kind, the anode portion can be purged by means of the purge unit, for example by opening a purge valve of the purge unit. As soon as the purge valve is opened or the purge procedure is started, the pressure in the anode portion drops. A pressure drop of this kind can lead to a critical pressure difference between the anode portion and the cathode portion, which can damage the membrane. In order to prevent this, it is known in the prior art to detect such a pressure drop using sensor units. As soon as the pressure drop has been detected, the pressure drop can be counteracted, for example, by suitably actuating the injector. However, the purge procedures take place relatively frequently in the highly dynamic operation of the fuel cell system and undesired pressure drops and resulting stress-induced damage in the fuel cell stack can still occur due to the delay between the pressure drop and the implementation of countermeasures.

The object of the present invention is to address the problem described above at least in part. In particular, the object of the present invention is to provide a method for adjusting an operating mode of a fuel cell system and to provide a fuel cell system of this kind, by means of which stress-induced damage can be prevented in a simple and reliable manner. Furthermore, the object of the present invention is to provide a computer program product and a memory means having a computer program product stored thereon for carrying out a method of this kind.

The object outlined above is achieved by means of the patent claims. In particular, the object outlined above is achieved by the method according to claim 1, the fuel cell system according to claim 5, the computer program product according to claim 9 and the memory means according to claim 10. Additional advantages of the invention can be derived from the dependent claims, the description and the drawings. Features and details that are described in relation to the method naturally also apply in relation to the fuel cell system according to the invention, the computer program product according to the invention, the memory means according to the invention, and vice versa in each case, and therefore reference is or can always be made interchangeably to the individual aspects of the invention with regard to that which is disclosed.

According to a first aspect of the present invention, a method for adjusting an operating mode of a fuel cell system is proposed. The fuel cell system comprises at least one fuel cell stack having an anode portion and a cathode portion, an anode supply line for conveying fuel from a fuel source to the anode portion, a fuel supply device for supplying the fuel in the anode supply line to the anode portion, an anode discharge line for discharging anode exhaust gas from the anode portion into the environment, and a purge unit for purging the anode portion. The method comprises the following steps:
determining a purge start time and/or a purge duration in which the anode portion is intended to be purged by the purge unit, and
shifting the fuel supply device from a normal operation into a fuel-supply operation specific to the purge operation on the basis of the determined purge start time and/or purge duration, wherein the shifting into the fuel-supply operation specific to the purge operation is carried out temporally before and/or during the determined purge duration.

Within the scope of the method according to the invention, the fuel supply device is thus then set to the fuel-supply operation specific to the purge operation even when the purge procedure has not yet taken place or at least has not fully taken place. That is to say, according to the invention, the fuel supply device can be adjusted in advance with a view to the fuel-supply operation specific to the purge operation or to each fuel-supply operation specific to each purge operation. This is implemented in the present case with the aim, in particular, of preventing any pressure difference between the anode portion and the cathode portion as tar as possible and not, as was typical in the past, correcting said pressure difference afterwards. In other words, the fuel supply device can be shifted from normal operation into the fuel-supply operation specific to the purge operation on the basis of the determined purge start time and/or purge duration for preventively equalizing the pressure between the anode portion and the cathode portion.

For this purpose, the fuel supply device is preferably adjusted such that a mass flow rate of the fuel is increased in the fuel-supply operation specific to the purge operation compared with normal operation, as a result of which the desired pressure equalization can be realised accordingly.

On account of the high mass flow rate through the anode stack outlet when the purge valve is open, the mass flow rate at the anode outlet increases and the pressure at the stack outlet decreases. This causes a pressure at the fuel cell stack inlet to decrease. By means of the method according to the invention, it is possible to know when the valve will open. As a result, the injection time of the anode supply device (injector and/or ejector system, pressure regulator, etc.) can be modified in order to ensure that the anode supply mass flow rate is increased and a stable pressure is achieved at the anode inlet.

The fuel supply unit is preferably arranged in and/or on the anode supply line. That is to say, the fuel supply unit may form part of the anode supply line. The fuel supply unit may accordingly be arranged upstream of the anode portion and downstream of the fuel source. The fuel source may be provided in the form of a fuel tank.

The purge unit is preferably arranged in and/or on the anode discharge line. That is to say, the purge unit may form part of the anode discharge line. The purge unit may accordingly be arranged downstream of the anode portion. The purge unit is preferably designed in the form of a purge valve or discharge valve or comprises a corresponding valve. The purge valve can be switched from an off-state into an on-state in order to purge the anode portion.

The anode supply line can be understood to be an anode gas supply line through which an operating fluid such as hydrogen and/or a hydrocarbon fuel can be conveyed to an inlet portion of the anode portion, if applicable together with water vapour. The anode discharge line can be understood to be an anode exhaust gas line that conveys anode gas or used fuel into the environment via an outlet portion of the anode portion. The anode gas supply line and the anode gas discharge line can in each case be understood to be a corresponding line system. That is to say, the relevant line is not necessarily restricted to a single pipeline, but rather may also comprise functional components by means of which the relevant fluid can be at least partially conveyed.

The shifting into the fuel-supply operation specific to the purge operation is preferably exclusively carried out temporally before the determined purge start time, i.e. before the start of the purge procedure. Nevertheless, the fuel supply device may also be switched into the fuel-supply operation specific to the purge operation at the start of purging and/or shortly thereafter.

The at least one fuel cell stack in each case comprises an anode portion, a cathode portion and an electrolyte membrane, which is received in a sandwich-like manner between the anode portion and the cathode portion. The fuel supply device can be shifted from normal operation into the fuel-supply operation specific to the purge operation on the basis of the determined purge start time and/or purge duration for preventively equalizing the pressure between the anode portion and the cathode portion in order to protect the electrolyte membrane.

Within the context of the invention, the purge start time is to be understood as the point in time at which the purge procedure is started for purging the anode portion and/or an anode path that at least partially comprises the anode supply line, the anode discharge line and a recirculation line for recirculating anode exhaust gas into the anode supply line and/or into the anode portion. In particular, the purge start time is understood to be a point in time at which preferably a valve (purge valve) is opened in order to start the purge.

Within the context of the invention, the purge duration is to be understood as the time in which the purge procedure is carried out for purging the anode portion and/or an anode path that at least partially comprises the anode supply line, the anode discharge line and a recirculation line for recirculating anode exhaust gas into the anode supply line and/or into the anode portion. In particular, the purge duration is thus understood to be each period of time during which preferably a valve (purge valve) is open (in an open position).

Particularly preferably, both the purge start time and the purge duration are determined. According to another embodiment of the present invention, it is possible for the fuel supply device to comprise at least one injector and for a duty cycle and/or injection frequency of the injector to be adjusted by shifting the fuel supply device from normal operation into the fuel-supply operation specific to the purge operation. By adjusting or regulating the duty cycle and/or injection frequency of the injector, the fuel mass flow rate to the anode portion can be influenced in a simple and reliable manner. It is thus possible to react to imminent pressure differences and/or to produce the desired pressure equalisation in a simple and reliable manner. The injector may be designed in the form of an injection nozzle, an ejector or preferably as an injector-ejector. The duty cycle is the ratio of the pulse duration to the period duration for a periodic sequence of pulses in accordance with standards. The duty cycle is in a range of between 0 and 1 or 0% and 100%. When the injector is shifted from normal operation into the fuel-supply operation specific to the purge operation, the value of the duty cycle can be increased by a predefinable and/or calculable value. Moreover, when the injector is shifted from normal operation into the fuel-supply operation specific to the purge operation, the injection frequency can be increased by a predefinable value. By adjusting the injection frequency, an injection rate for injecting the fuel to and/or into the anode portion can be adjusted. According to the invention, two, three or more injectors may be provided. It is advantageous if a recirculation line is also provided.

Furthermore, in a method according to the present invention, it is possible for the fuel cell system to comprise a recirculation line for conveying anode exhaust gas from the anode portion to the fuel supply device as well as a recirculation pump for pumping the anode exhaust gas through the recirculation line to the fuel supply device, wherein the recirculation pump is shifted from a normal operation into a pump operation specific to the purge operation on the basis of the determined purge start time and/or purge duration, and wherein the shifting into the pump operation specific to the purge operation is carried out temporally before and/or during the determined purge duration. It has been found to be advantageous for the desired pressure equalisation if the pump operation of the recirculation pump is also preventively switched into a predeterminable operating mode for increasing the mass flow rate of the recirculated anode exhaust gas in a controlled manner. This can also be achieved using control and/or regulation technology in a quick, simple and reliable manner. The recirculation pump is advantageously installed in combination with a pressure regulator or is used with a pressure regulator.

In principle, it is advantageous if either the above-described injector solution, in particular applied as an injector-ejector principle, or a recirculation pump having a pressure regulator is used, wherein these may also be combined. In any case, it is advantageous if a recirculation line is provided. An injector-ejector and/or a recirculation pump having a pressure regulator is then advantageously arranged in said recirculation line. Furthermore, in a method according to the invention, it is possible for a pressure difference between the anode portion and the cathode portion to be determined, in particular continuously determined, wherein the fuel-supply operation of the fuel supply device specific to the purge operation and/or the pump operation of the recirculation pump specific to the purge operation are regulated on the basis of the determined pressure difference. As such, a differential pressure between the anode portion and the cathode portion can be kept at the desired value in a simple and reliable manner. The shifting of the fuel supply device into the fuel-supply operation specific to the purge operation is thus not necessarily restricted to a one-time control step, but rather can be understood to be a control loop. In other words, the fuel-supply operation specific to the purge operation can be continuously regulated before and/or during the determined purge duration depending on various measurement parameters.

According to another aspect of the present invention, a fuel cell system is provided. The fuel cell system comprises a fuel cell stack having an anode portion and a cathode portion, an anode supply line for conveying fuel from a fuel source to the anode portion, a fuel supply device for supplying the fuel in the anode supply line to the anode portion, an anode discharge line for discharging anode exhaust gas from the anode portion into the environment surrounding the fuel cell system, and a purge unit for purging the anode portion. The fuel cell system further comprises a purge time determination unit for determining a purge start time and/or a purge duration in which the anode portion is intended to be purged by the purge unit, and a shifting unit for shifting the fuel supply device from a normal operation into a fuel-supply operation specific to the purge operation temporally before and/or during the determined purge duration on the basis of the determined purge start time. As such, a fuel cell system according to the invention brings the same advantages as those described in detail in relation to the device according to the invention.

Analogously to the above-described method, in a fuel cell system according to the invention, it is possible for the fuel supply device to comprise an injector or to be designed as such and for the shifting unit to comprise at least one setting means for shifting the fuel supply device from normal operation into the fuel-supply operation specific to the purge operation by adjusting a duty cycle and/or injection frequency of the injector. As already explained above, the injector may be designed in the form of an injection nozzle, an ejector or an injector-ejector. In the latter design variant, the injector may comprise a nozzle for supplying a primary fuel in the form of the fuel from the fuel source into a mixing chamber of the injector. Furthermore, the injector may comprise a secondary fuel inlet for admitting secondary fuel in the form of recirculated anode exhaust gas into the mixing chamber. Moreover, the injector may in this case comprise a diffuser downstream of the mixing chamber and the nozzle, through which diffuser a fuel mixture consisting of the primary fuel and the secondary fuel and [sic] can be discharged in a pressurised manner towards the anode portion and/or into the anode portion. The setting unit may comprise a duty cycle module for adjusting or controlling and/or regulating the duty cycle. Moreover, the setting unit may comprise a frequency module for adjusting or controlling and/or regulating the injection frequency. By providing the respective modules separately, the injector can be adjusted in an efficient and reliable manner.

It may also be advantageous if, in a fuel cell system according to the invention, a recirculation line is designed to convey anode exhaust gas from the anode portion to the fuel supply device and if a recirculation pump is designed to pump the anode exhaust gas through the recirculation line to the fuel supply device, wherein the shifting unit comprises a pump module for shifting the recirculation pump, on the basis of the determined purge start time and/or purge duration, from a normal operation into a pump operation specific to the purge operation temporally before and/or after the determined purge start time. In principle, the shifting unit may preferably also comprise a pump module for shifting the recirculation pump, on the basis of the determined purge start time and/or purge duration, from a normal operation into a pump operation specific to the purge duration precisely at the determined purge start time. The recirculation pump may be arranged in and/or on the recirculation line, in particular downstream of an anode outlet of the anode portion and upstream of an anode inlet of the anode portion. The recirculation line is preferably designed to feed the anode exhaust gas from the anode portion via the anode discharge line and the anode supply line back to the anode portion.

That is to say, the recirculation line may also be designed as a connection line for a fluid connection between the anode discharge line and the anode supply line.

In another embodiment of the present invention, the fuel cell system comprises a pressure determination unit for determining a pressure difference between the anode portion and the cathode portion, wherein the shifting unit comprises a regulation unit for regulating the fuel-supply operation of the fuel supply device specific to the purge operation and/or the pump operation of the recirculation pump specific to the purge operation on the basis of the determined pressure difference. As a result, the advantages described above with regard to the corresponding method can be achieved.

According to another aspect of the present invention, a computer program product is proposed, which comprises commands that prompt a computer to carry out the above-described method when said computer program product is executed by said computer. As such, a computer program product according to the invention also brings the advantages described above. The computer program product may be implemented as a computer-readable instruction code in any suitable programming language, for example JAVA, Matlab, Python, C# and/or C++. The computer program product may be saved on a computer-readable storage medium such as a data disc, a removable drive, a volatile or non-volatile memory, or a built-in memory/processor. The instruction code may program a computer or other programmable devices, such as a controller, to perform the desired functions. Furthermore, the computer program product may be provided in a network, such as the Internet, from which it can be downloaded by a user as needed. The computer program product may be realised by means of a computer program, i.e. a piece of software, and by means of one or more special electronic circuits, i.e. a piece of hardware, or be in any hybrid form, i.e. by means of software components and hardware components. Within the context of the invention, a computer is understood to be any playback device that is designed to execute the computer program product.

Furthermore, within the scope of the invention, a memory means having stored thereon a computer program product of the like described above is proposed. The memory means is in particular to be understood as a non-volatile memory means. The memory means may be in the form of a data disc, a removable drive or a processor or controller. That is to say, according to the invention, a controller having installed thereon a computer program product of the like described above is also proposed. The controller may comprise the pressure determination unit, the purge time determination unit for determining the imminent purge start time and/or purge duration as well as the shifting unit having setting means, the regulation unit for shifting the fuel supply device from normal operation into the fuel-supply operation specific to the purge operation and the pump module for shifting the recirculation pump from a normal operation into a pump operation specific to the purge operation on the basis of the determined purge start time and/or purge duration. The respective functional units may be implemented in the form of software and/or hardware components of the controller.

Other measures that improve the invention can be deduced from the following description of various exemplary embodiments of the invention, which are represented schematically in the figures, in which:

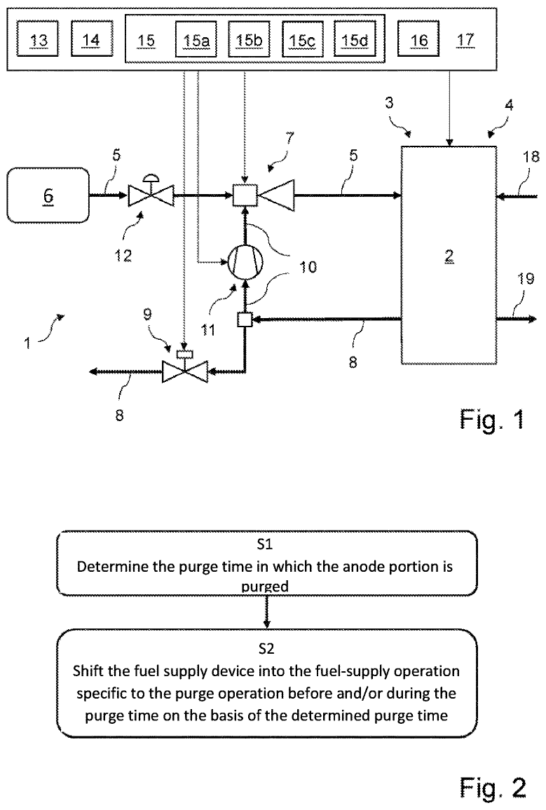

FIG. 1 is a block diagram for describing a fuel cell system according to a preferred embodiment of the present invention.

FIG. 2 is a flow diagram for explaining a method according to a first embodiment of the present invention, and

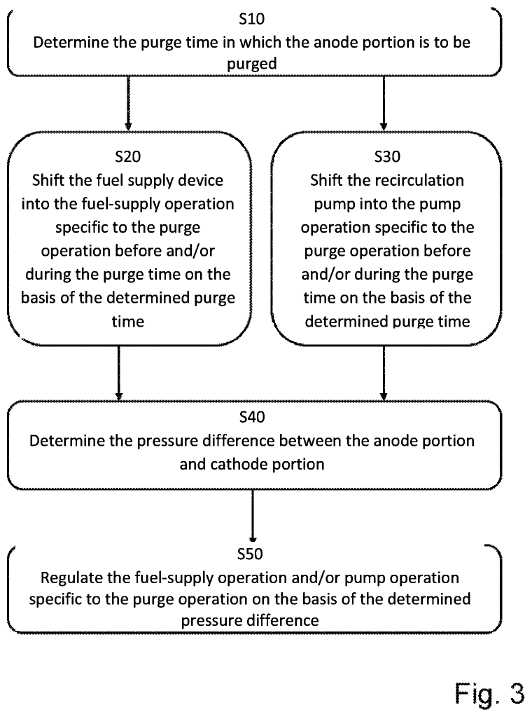

FIG. 3 is a flow diagram for explaining a method according to a second embodiment of the present invention.

FIG. 1 is a schematic block diagram for describing a fuel cell system 1 according to a preferred embodiment. The fuel cell system 1 comprises a fuel cell stack 2 having an anode portion 3 and a cathode portion 4. Moreover, the fuel cell system 1 comprises an anode supply line 5 for conveying fuel from a fuel source 6 to the anode portion 3, a fuel supply device 7 for supplying the fuel through the anode supply line 5 to the anode portion 3, an anode discharge line 8 for discharging anode exhaust gas from the anode portion 3 into the environment surrounding the fuel cell system 1, and a purge unit 9 for purging the anode portion 3. Furthermore, the fuel cell system 1 comprises a cathode supply line 18 for conveying cathode gas, in particular in the form of air, to the cathode portion 4 as well as a cathode discharge line 19 for conveying cathode exhaust gas or cathode exhaust air away from the cathode portion 4 into the environment surrounding the fuel cell system 1. A pressure reduction unit 12 in the form of a shut-off valve is arranged upstream of the fuel supply device 7 and downstream of the fuel source 6 for reducing the pressure in the anode supply line 5 and, accordingly, in the anode portion 3.

The fuel cell system further 1 comprises a controller 17 having a purge time determination unit 14 for determining a purge start time and/or a purge duration in which the anode portion 3 is intended to be or is purged by the purge unit 9, and a shifting unit 15 for shifting the fuel supply device 7 from a normal operation into a fuel-supply operation specific to the purge operation temporally before and/or during the determined purge duration on the basis of the determined purge start time.

The fuel supply device 7 is designed in the form of at least one injector-ejector. In principle, multiple injectors and/or ejectors and/or combinations thereof may also be provided. The shifting unit 15 comprises two setting means in the form of a duty cycle module 15a and a frequency module 15b for shifting the fuel supply device 7 from normal operation into the fuel-supply operation specific to the purge operation by adjusting a duty cycle and/or an injection frequency of the injector. That is to say, in order to increase the mass flow rate of the fuel to the anode portion 3 and thus to counteract the pressure drop during purging, the duty cycle can be increased by means of the duty cycle module 15a and the injection frequency can be increased by means of the frequency module 15b.

Furthermore, in the fuel cell system 1, a recirculation line 10 is designed to convey anode exhaust gas from the anode portion 3 to the fuel supply device 7 and a recirculation pump 11 is designed to pump the anode exhaust gas through the recirculation line 10 to the fuel supply device 7, wherein the shifting unit 15 comprises a pump module 15c for shifting the recirculation pump 11, on the basis of the determined purge start time and/or purge duration, from a normal operation into a pump operation specific to the purge operation temporally before the determined purge start time.

According to the invention, it may also be advantageous for either at least one injector-ejector or a recirculation pump 11 to be provided. It is not necessary for these to be combined as in FIG. 1. If the recirculation line 10 is designed without an injector-ejector, a pressure regulator and/or the recirculation pump 11 is provided instead of the injector-ejector.

Furthermore, the controller 17 comprises a pressure determination unit 13 for determining a pressure difference between the anode portion 3 and the cathode portion 4, wherein the shifting unit 15 comprises a regulation unit 15d for regulating the fuel-supply operation of the fuel supply device 7 specific to the purge operation on the basis of the determined pressure difference.

A computer program product 16 is also installed on the controller 17 and comprises commands that prompt a computer, in the present case in the form of the controller 17, to carry out a method described below with reference to FIG. 2 when said computer program product 16 is executed by said computer/controller.

According to the flow diagram shown in FIG. 2, an imminent purge duration in which the anode portion is intended to be purged by the purge unit 9 is initially determined in a first step S1. In a subsequent step S2, the fuel supply device 7 is shifted or adjusted from a normal operation into a fuel-supply operation specific to the purge operation on the basis of the determined purge duration, wherein the shifting into the fuel-supply operation specific to the purge operation is carried out temporally before and/or during the determined purge duration. With reference to the fuel cell system 1 shown in the FIG. 1 and the fuel supply device 7 integrated in said system in the form of an injector-ejector, a duty cycle and an injection frequency of the injector-ejector is adjusted when the fuel supply device 7 is shifted from normal operation into the fuel-supply operation specific to the purge operation.

FIG. 3 is a flow diagram for explaining a method for adjusting the fuel cell system 1 according to a second embodiment. The steps S10 and S20 correspond to the steps S1 and S2 of the method explained with reference to FIG. 2. In addition to step S20, another step S30 is performed, in which the recirculation pump 11 is shifted from a normal operation into a pump operation specific to the purge operation on the basis of the determined purge duration, wherein the shifting into the pump operation specific to the purge operation is also carried out temporally before and/or during the determined purge duration. Subsequently, in a step S40, a pressure difference between the anode portion 3 and the cathode portion 4 is continuously determined. In a subsequent step S50, the fuel-supply operation of the fuel supply device 7 specific to the purge operation and/or the pump operation of the recirculation pump 11 specific to the purge operation are regulated on the basis of the determined pressure difference.

The invention allows other design principles in addition to the embodiments set out above. In other words, the invention should not be considered limited to the exemplary embodiments explained with reference to the figures.

### LIST OF REFERENCE SIGNS

1 Fuel cell system
2 Fuel cell stack
3 Anode portion
4 Cathode portion
5 Anode supply line
6 Fuel source
7 Fuel supply device
8 Anode discharge line
9 Purge unit
10 Recirculation line
11 Recirculation pump
12 Pressure reduction unit
13 Pressure determination unit
14 Purge time determination unit
15 Shifting unit
15a Duty cycle module (setting means)
15b Frequency module (setting means)
15c Pump module
15d Regulation unit
16 Computer program product
17 Controller
18 Cathode supply line
19 Cathode discharge line

1. Method for adjusting an operating mode of a fuel cell system (1), which comprises at least one fuel cell stack (2) having an anode portion (3) and a cathode portion (4), an anode supply line (5) for conveying fuel from a fuel source (6) to the anode portion (3), a fuel supply device (7) for supplying the fuel in the anode supply line (5) to the anode portion (3), an anode discharge line (8) for discharging anode exhaust gas from the anode portion (3) into the environment, and a purge unit (9) for purging the anode portion (3), said method comprising the steps of:
determining a purge start time and/or a purge duration in which the anode portion (3) is intended to be purged by the purge unit (9), and
shifting the fuel supply device (7) from a normal operation into a fuel-supply operation specific to the purge operation on basis of the determined purge start time and/or purge duration, wherein the shifting into the fuel-supply operation specific to the purge operation is carried out temporally before and/or during the determined purge duration.

2. Method according to claim 1,
characterised in that
the fuel supply device (7) comprises at least one injector and a duty cycle and/or injection frequency of the injector is adjusted by shifting the fuel supply device (7) from normal operation into the fuel-supply operation specific to the purge operation.

3. Method according to claim 1, characterised in that
the fuel cell system (1) comprises a recirculation line (10) for conveying anode exhaust gas from the anode portion (3) to the fuel supply device (7) as well as a recirculation pump (11) for pumping the anode exhaust gas through the recirculation line (10) to the fuel supply device (7), wherein the recirculation pump (11) is shifted from a normal operation into a pump operation specific to the purge operation on the basis of the determined purge start time and/or purge duration, and wherein the shifting into the pump operation specific to the purge operation is carried out temporally before and/or during the determined purge duration.

4. Method according to claim 1, characterised in that
a pressure difference between the anode portion (3) and the cathode portion (4) is determined and the fuel-supply operation of the fuel supply device (7) specific to the purge operation and/or the pump operation of the recirculation pump (11) specific to the purge operation are regulated on the basis of the determined pressure difference.

5. Fuel cell system (1), comprising a fuel cell stack (2) having an anode portion (3) and a cathode portion (4), an anode supply line (5) for conveying fuel from a fuel source (6) to the anode portion (3), a fuel supply device (7) for supplying the fuel in the anode supply line (5) to the anode portion (3), an anode discharge line (8) for discharging anode exhaust gas from the anode portion (3) into the environment, and a purge unit (9) for purging the anode portion (3), characterised by
a purge time determination unit (14) for determining a purge start time and/or a purge duration in which the anode portion (3) is intended to be purged by the purge unit (9), and a shifting unit (15) for shifting the fuel supply device (7) from a normal operation into a fuel-supply operation specific to the purge operation temporally before and/or during the determined purge duration on the basis of the determined purge start time and/or purge duration.

6. Fuel cell system (1) according to claim 5,
characterised in that
the fuel supply device (7) comprises at least one injector as well as the shifting unit (15) having at least one setting means (15a, 15b) for shifting the fuel supply device (7) from normal operation into the fuel-supply operation specific to the purge operation by adjusting a duty cycle and/or an injection frequency of the injector.

7. Fuel cell system (1) according to claim 5,
characterised by
a recirculation line (10) for conveying anode exhaust gas from the anode portion (3) to the fuel supply device (7) and a recirculation pump (11) for pumping the anode exhaust gas through the recirculation line (10) to the fuel supply device (7), wherein the shifting unit (15) comprises a pump module (15c) for shifting the recirculation pump (11), on the basis of the determined purge time, from a normal operation into a pump operation specific to the purge operation temporally before and/or after the determined purge start time.

8. Fuel cell system (1) according to claim 5,
characterised in that
the fuel cell system (1) comprises a pressure determination unit (13) for determining a pressure difference between the anode portion (3) and the cathode portion (4), wherein the shifting unit (15) comprises a regulation unit (15d) for regulating the fuel-supply operation of the fuel supply device (7) specific to the purge operation and/or the pump operation of the recirculation pump (11) specific to the purge operation on the basis of the determined pressure difference.

9. Computer program product (16), comprising commands that prompt a computer to carry out the method according to claim 1 when said computer program product (16) is executed by said computer.

10. Memory means having stored thereon a computer program product (16) according to claim 9.

11. Method according to claim 2,
characterised in that
the fuel cell system (1) comprises a recirculation line (10) for conveying anode exhaust gas from the anode portion (3) to the fuel supply device (7) as well as a recirculation pump (11) for pumping the anode exhaust gas through the recirculation line (10) to the fuel supply device (7), wherein the recirculation pump (11) is shifted from a normal operation into a pump operation specific to the purge operation on the basis of the determined purge start time and/or purge duration, and wherein the shifting into the pump operation specific to the purge operation is carried out temporally before and/or during the determined purge duration.

12. Method according to claim 2,
characterised in that
a pressure difference between the anode portion (3) and the cathode portion (4) is determined and the fuel-supply operation of the fuel supply device (7) specific to the purge operation and/or the pump operation of the recirculation pump (11) specific to the purge operation are regulated on the basis of the determined pressure difference.

13. Method according to claim 3,
characterised in that
a pressure difference between the anode portion (3) and the cathode portion (4) is determined and the fuel-supply operation of the fuel supply device (7) specific to the purge operation and/or the pump operation of the recirculation pump (11) specific to the purge operation are regulated on the basis of the determined pressure difference.

14. Fuel cell system (1) according to claim 6,
characterised by
a recirculation line (10) for conveying anode exhaust gas from the anode portion (3) to the fuel supply device (7) and a recirculation pump (11) for pumping the anode exhaust gas through the recirculation line (10) to the fuel supply device (7), wherein the shifting unit (15) comprises a pump module (15c) for shifting the recirculation pump (11), on the basis of the determined purge time, from a normal operation into a pump operation specific to the purge operation temporally before and/or after the determined purge start time.

15. Fuel cell system (1) according to claim 6,
characterised in that
the fuel cell system (1) comprises a pressure determination unit (13) for determining a pressure difference between the anode portion (3) and the cathode portion (4), wherein the shifting unit (15) comprises a regulation unit (15d) for regulating the fuel-supply operation of the fuel supply device (7) specific to the purge operation and/or the pump operation of the recirculation pump (11) specific to the purge operation on the basis of the determined pressure difference.

16. Fuel cell system (1) according to claim 7,
characterised in that
the fuel cell system (1) comprises a pressure determination unit (13) for determining a pressure difference between the anode portion (3) and the cathode portion (4), wherein the shifting unit (15) comprises a regulation unit (15d) for regulating the fuel-supply operation of the fuel supply device (7) specific to the purge operation and/or the pump operation of the recirculation pump (11) specific to the purge operation on the basis of the determined pressure difference.

17. Computer program product (16), comprising commands that prompt a computer to carry out the method according to claim 2 when said computer program product (16) is executed by said computer.

18. Computer program product (16), comprising commands that prompt a computer to carry out the method according to claim 3 when said computer program product (16) is executed by said computer.

19. Computer program product (16), comprising commands that prompt a computer to carry out the method according to claim 4 when said computer program product (16) is executed by said computer.
